(19) United States
(12) Patent Application Publication
(10) Pub. No.: US 2004/0145676 A1
(43) Pub. Date: Jul. 29, 2004

(54) Digital camera for a computer

(75) Inventor: Su Yueh Lin, Taoyuan Hsien (TW)

Correspondence Address: BACON & THOMAS, PLLC, 625 SLATERS LANE, FOURTH FLOOR, ALEXANDRIA, VA, 22314

(73) Assignee: NIKKO-ENERGY TECHNOLOGY CORPORATION, Taoyuan Hsien (TW)

(21) Appl. No.: 10/420,802

(22) Filed: Apr. 23, 2003

(30) Foreign Application Priority Data
Jan. 28, 2003 (TW) 92202112

(51) Int. Cl. H04N 5/225

(52) U.S. Cl. 348/374

(57) ABSTRACT

A digital camera for a computer includes a digital camera connected with a USB plug with an electric wire wholly surrounded with a flexible tube so that the digital camera may be adjusted in its direction and its angle according to need of taking pictures without need of adjusting the position of a computer to be connected with the digital camera. And a microphone and a shining lamp are further provided with the digital camera for optional use.

### BACKGROUND OF THE INVENTION

1. Field of the Invention

This invention relates to a digital camera for a computer, particularly to one having a flexible tube surrounding wholly an electric wire connected between a digital camera and a USB (universal serial bus) plug so as to freely bend the flexible tube together with the electric wire so that the digital camera may be adjusted in its direction and angle for taking a picture, without need of adjusting the position of a computer connected with the digital camera.

2. Description of the Prior Art

A conventional digital camera for a computer is mostly positioned in a display of a computer, with its body hidden in the housing of the display and its lens exposed out of the display. So this kind of digital camera for a computer can only take pictures in a definite direction and angle, impossible to change the direction or the angle, even if needed to. Then a conventional digital camera 1 for a computer (A) as shown in FIG. 1 has been made, having a digital camera 1 positioned on an upper side of a display (Al) of a computer (A) so that the digital camera 1 may be adjusted its angle to the right and the left, but it is not freely adjusted in other direction and angles, inconvenient to use.

### SUMMARY OF THE INVENTION

This invention has been devised to offer a digital camera for a computer possible to be adjusted in its direction and its angle freely for convenience of taking pictures.

The feature of the invention is a flexible tube surrounding completely an electric wire connecting a digital cameral and a USB plug to be inserted in a socket of a computer.

### BRIEF DESCRIPTION OF DRAWINGS

This invention will be better understood by referring to the accompanying drawings, wherein:

FIG. 1 is a perspective view of a conventional digital camera combined with a computer;

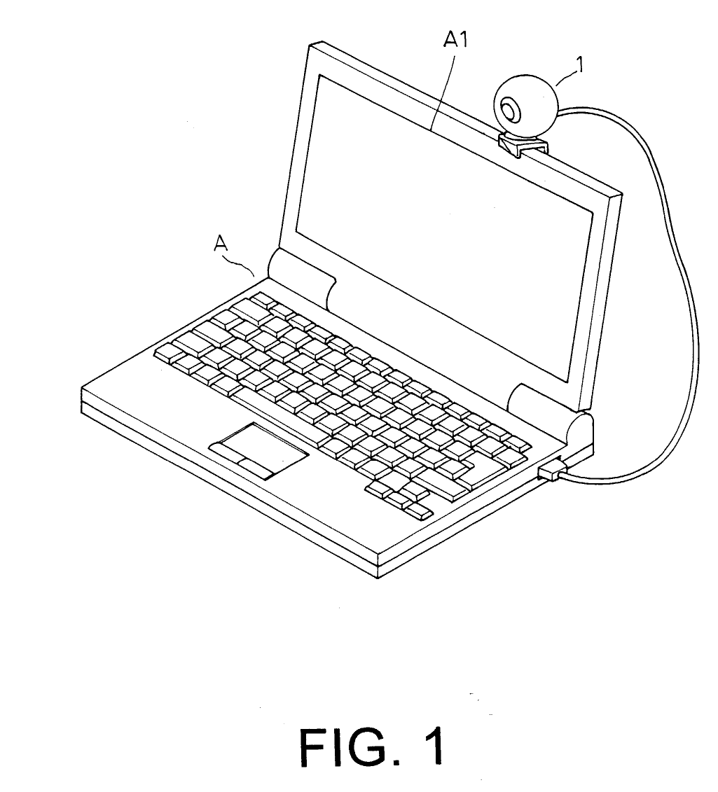

FIG. 2 is a perspective view of a digital camera for a computer in the present invention;

FIG. 3 is a perspective view of a flexible tube in the present invention;

FIG. 4 is a perspective view of the digital camera combined with a computer in the present invention, showing a mode of using the camera;

FIG. 5 is a perspective view of the digital camera combined with a computer in the present invention, showing another mode of using the camera;

FIG. 6 is a perspective view of the digital camera for a computer in the present invention, showing it using a shining lamp; and,

FIG. 7 is a perspective view of the digital camera for a computer in the present invention, showing it using a microphone.

### DETAILED DESCRIPTION OF THE PREFERRED EMBODIMENT

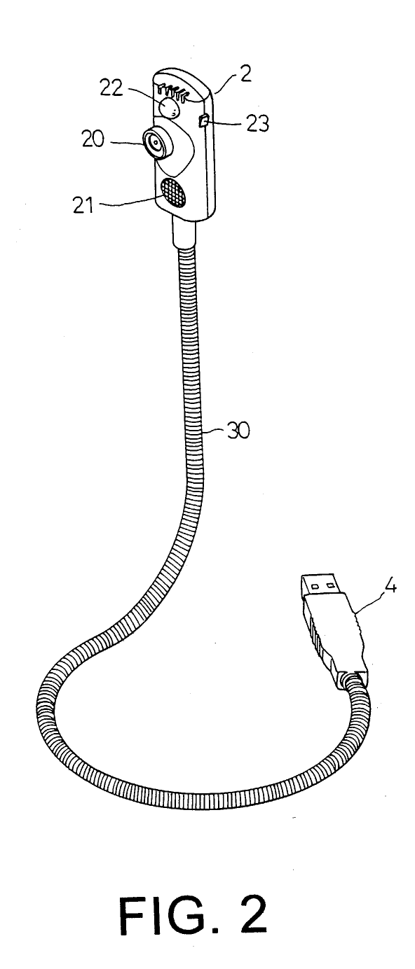

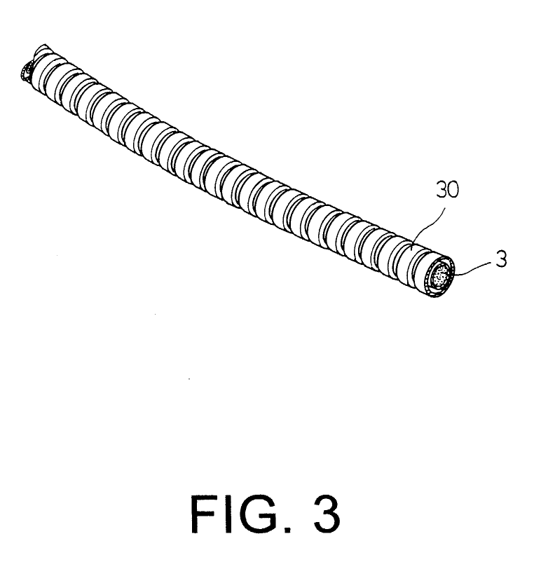

A preferred embodiment of a digital cameral for a computer in the present invention, as shown in FIGS. 2 and 3, includes a digital camera 2, an electric wire 3 and a USB (universal serial bus) plug 4 as main components.

The digital camera 2 has a lens 20 positioned in the center, a microphone 21 provided below the lens 20, a shining lamp 22 fixed above the lens 20, and a switch 23 near the shining lamp 22.

The electric wire 3 has an end connected to the lower side of the digital camera 2, and the other end connected to the USB plug 4, completely surrounded by a flexible tube 30 to protect the electric wire 3 and permit the electric wire 3 to freely bend to enable the digital camera 2 adjusted and positioned to face any direction and angle.

The USB plug 4 is connected with the electric wire 3 and can be inserted in a socket of a computer (A).

Further a microphone 21 and a shining lamp 22 may be added to the digital camera 2 for optionally used in case of necessity.

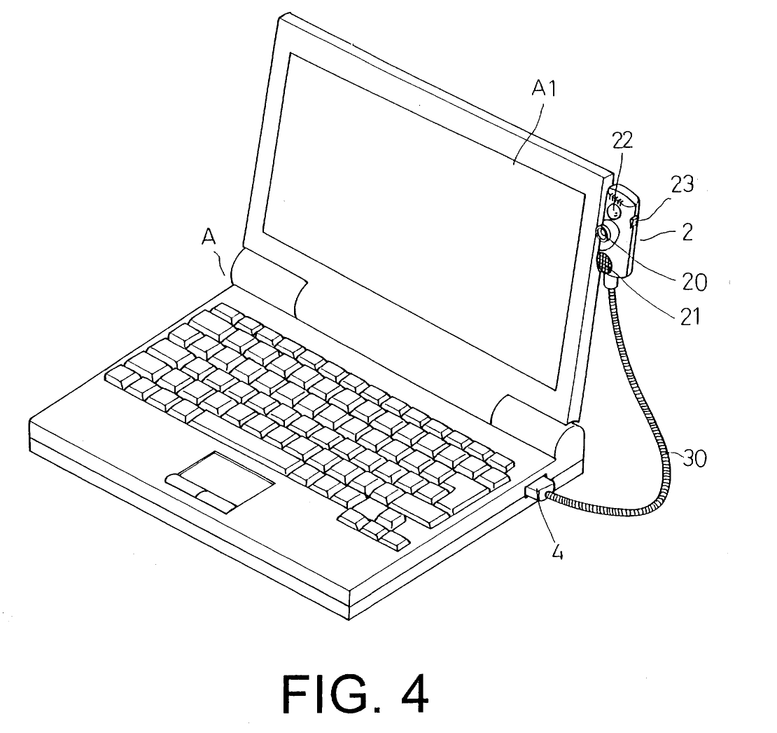

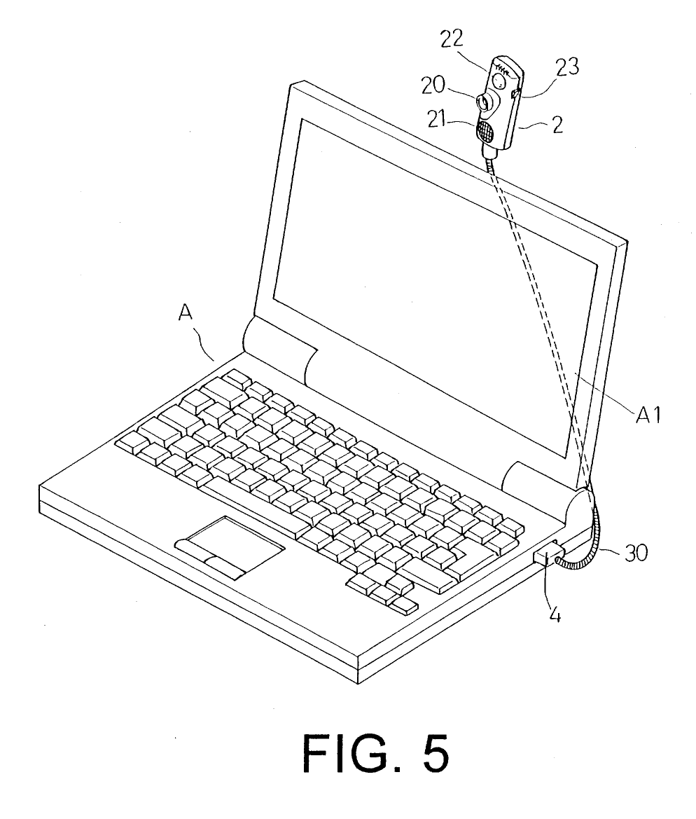

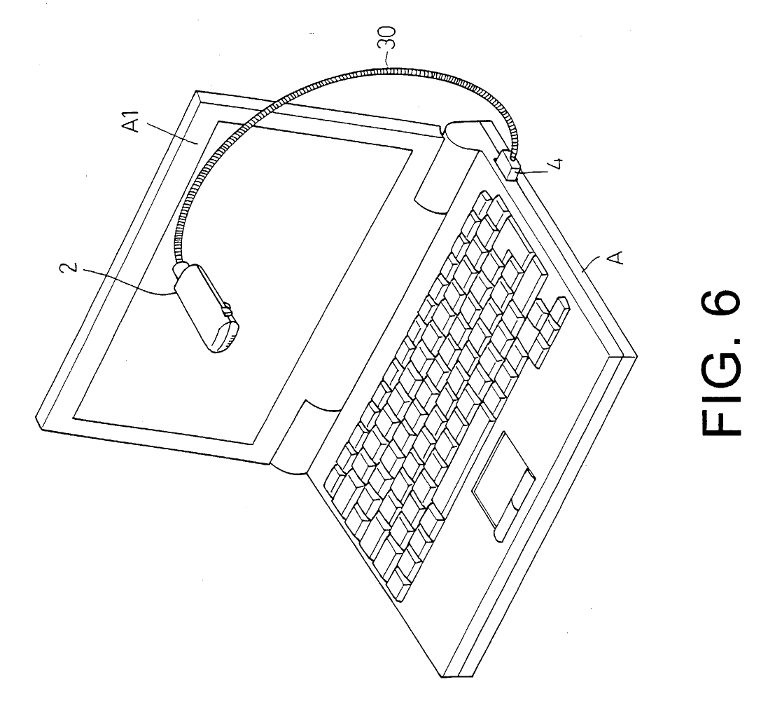

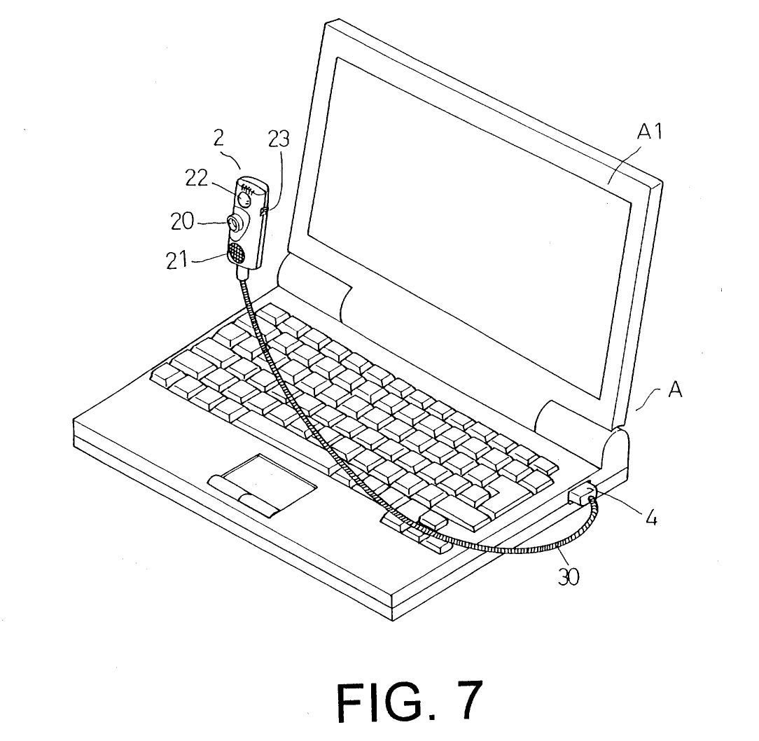

In using the digital camera 2 for a computer (A) in the invention, at first insert the USB plug 4 in a socket of a computer (A), and then adjust the direction and the angle of the digital camera 2 according to the needed angle for taking pictures by handling the electric wire 3 with the flexible tube 30, as shown in FIGS. 4 and 5. If necessary, the microphone 21 and the shining lamp 22 can also be used as shown in FIGS. 6 and 7.

The digital camera for a computer in the invention has the following advantages, as can be understood from the foresaid description.

1. The digital camera 2 can be adjusted in its direction and angle freely so as to suit to necessity, without need of adjusting the position of a computer (A) connected to the digital camera 2, convenient to handle.

2. There arises no such problem in positioning the digital camera 2 in the invention by handling the flexible tube 30 as that of the conventional digital camera 2 for a computer (A).

3. As a microphone 21 and a shining lamp 22 are provided additionally with the digital camera 2, the cost for these components can be saved.

While the preferred embodiment of the invention has been described above, it will be recognized and understood that various modifications may be made therein and the appended claims are intended to cover all such modifications that may fall within the spirit and scope of the invention.

What is claimed is:

1. A digital camera for a computer includes a digital camera, an electric wire, and a USB plug, and characterized by;
A flexible tube provided to surround all the length of said lead wire connected between said digital camera and said USB plug which is possible to be inserted in a socket of a computer, said electric wire together with said flexible tube possible to be freely bent so as to adjust the direction and the angle of said digital camera connected to a computer for taking pictures easily, without need of adjusting the position and the angle of the computer.

2. The digital camera for a computer as claimed in claim 1, wherein said digital camera is further provided with a microphone and a shining lamp.
